(19) United States
(12) Patent Application Publication
(10) Pub. No.: US 2010/0137492 A1
(43) Pub. Date: Jun. 3, 2010

(54) Use of a Elastomer Blend as a Material in the Insertion Area of Fuel Cell

(75) Inventors: Matthias Adler, Heppenheim (DE); Ruth Bieringer, Bobenheim-Roxheim (DE); Michael Viol, Heidelberg (DE)

Correspondence Address: Pearl Cohen Zedek Latzer, LLP, 1500 Broadway, 12th Floor, New York, NY, 10036, US

(73) Assignee: Carl Freudenberg KG, Weinheim (DE)

(21) Appl. No.: 11/992,354

(22) PCT Filed: Sep. 14, 2006
(86) PCT No.: PCT/EP2006/008934

§ 371 Date: Feb. 16, 2010

(30) Foreign Application Priority Data
Sep. 21, 2005 (DE) 10 2005 045 184.5

(51) Int. Cl. C08K 3/26; C08L 83/05; C08L 83/06; C08K 3/34; C08K 3/22

(52) U.S. Cl. 524/424; 524/588; 524/442; 524/430; 524/401

(57) ABSTRACT

The use of a sulphur-free and low-emission elastomer blend which has properties of various rubbers, and the mechanical properties thereof are improved, in particular, in relation to the permanent set (DVR), elongation at rupture, tensile strength and/or gas permeability (permeation) in relation to the individual compounds, and it also has an improved temperature resistance and an improved resistance to media. The elastomer blend includes a rubber having at least two functional groups which can be cross-linked by hydrosilylation, at least one other rubber comprising at least two functional groups which can be cross-linked by hydrosilylation, and can be used as a material in the insertion area of the fuel cells, in particular, the direct-methanol-fuel cells. The rubber is chemically different from the rubber, a cross-linking agent includes a hydrosiloxane or hydrosiloxane derivative or a mixture of several hydrosiloxanes or derivatives, which include at least two SiH groups per molecule in the centre, a hydrosilylation catalyst system and at least one filling material.

### FIELD OF THE INVENTION

The invention relates to the use of an elastomer blend as a material in the area of application of fuel cells, especially of direct methanol fuel cells.

### DESCRIPTION OF RELATED ART

European patent application EP 1 075 034 A1 describes the use of polyisobutylene or perfluoropolyether, crosslinked by hydrosilylation, as a sealing material in fuel cells.

U.S. Pat. No. 6,743,862 B2 discloses a crosslinkable rubber composition, preferably consisting of ethylene propylene diene monomer, with a compound having at least two SiH groups and optionally with a platinum catalyst. Moreover, the use of this rubber composition as a sealing material is described.

European patent application EP 1 277 804 A1 discloses compositions made of a vinyl polymer having at least one alkenyl group that can be crosslinked by hydrosilylation, a compound having a component containing hydrosilyl groups, a hydrosilylation catalyst as well as an aliphatic unsaturated compound having a molecular weight of not more than 600 g/mol.

The blends known from European patent application EP 0 344 380 B1, which are crosslinked by sulfur or peroxide have a highly unsaturated rubber and two ethylene propylene non-conjugated diene terpolymers having different molecular weights.

The classic crosslinking chemistry of diene rubbers, such as a crosslinking by sulfur or peroxide, leads to a high content of volatile constituents in the crosslinked material and to products whose chemical properties can be markedly inferior to the values of the individual compounds. The reason for this can be poor mixing and insufficient co-vulcanization.

U.S. Pat. No. 6,875,534 B2 describes the use of a blend of polyisobutylene and silicon, crosslinked by hydrosilylation, as a seal in fuel cells. Silicons display poor compression set values in a moist environment such as, for example, in fuel cells, as well as in the case of prolonged use under pressure and at an elevated temperature.

European patent application EP 1 146 082 A1 discloses a method for crosslinking a blend of a thermoplastic resin and an unsaturated rubber, comprising isobutylene isoprene divinyl benzene, whereby the thermoplastic resin is inert with respect to the rubber, to the hydrosilylation agent and to the hydrosilylation catalyst.

### SUMMARY OF THE INVENTION

The invention is based on the objective of proposing the use of a sulfur-free and low-emission elastomer blend that has the properties of various rubbers, and whose mechanical properties, especially those relating to hardness, tensile strength, elongation at break, gas-permeability (permeation) and/or compression set, have been improved in comparison to the individual compounds, that is to say, in comparison to mixtures or compounds that only contain one type of rubber, said blend having an improved temperature resistance and media resistance.

The envisaged objective is achieved by the features of claim 1.

In order to be used as a material in the area of application of fuel cells, the elastomer blend according to the invention comprises a rubber (A) having at least two functional groups that can be crosslinked by hydrosilylation, at least one other rubber (B) having at least two functional groups that can be crosslinked by hydrosilylation—whereby rubber (B) differs chemically from rubber (A)—it comprises a hydrosiloxane or hydrosiloxane derivative or a mixture of several hydrosiloxanes or hydrosiloxane derivatives that, on average, have at least two SiH groups per molecule as the crosslinking agent (C), and it comprises a hydrosilylation catalyst system (D) as well as at least one filler (E).

Here, the elastomer blend is preferably essentially silicon-free and/or essentially thermoplastic-free, that is to say, the elastomer blend preferably contains ≦30 phr (parts per hundred of rubber) of silicon, especially preferably less than 20 phr of silicon, and/or preferably less than 30% by weight of a thermoplastic. Especially preferably, the elastomer blends are completely silicon-free and/or completely thermoplastic-free.

In view of the fact that the elastomer blends have little or no silicon, they entail the advantage that the permeation of fluids or gases through their constituent materials is much less than is the case with silicon rubber. The permanent deformation after load, especially at elevated temperatures of more than 80° C. [176° F.], of the type characterized by the compression set, is especially low in these rubbers, that is to say, the elastomer blends made of the crosslinked rubbers (A) and (B). This property stands out, for example, especially in comparison to thermoplastic elastomer blends that contain a thermoplastic. Since the physical crosslinking sites can slip off in case of a deformation, the permanent deformation of thermoplastic elastomers is higher than with rubber.

The subordinate claims constitute advantageous refinements of the subject matter of the invention.

In a preferred embodiment, the elastomer blend additionally comprises a co-agent (F) that can be crosslinked by hydrosilylation and/or else at least one additive (G).

The mechanical properties, especially the compression set, of elastomers crosslinked by hydrosilylation and made up of polymers that contain only two functional groups is usually highly dependent on the ratio of functional groups to SiH groups of the hydrosiloxanes. Therefore, elastomer blends are preferred that, on the average of all rubbers, have more than two functional groups that can be crosslinked by hydrosilylation.

In a preferred embodiment of the elastomer blend, rubber (A) has more than two functional groups that can be crosslinked by hydrosilylation, and the at least one rubber (B) has two functional groups that can be crosslinked by hydrosilylation, preferably two terminal vinyl groups.

In order to improve the mechanical properties of the elastomer blend, for example, in terms of the compression set, elongation at break and/or tensile strength, gas-permeability (permeation), especially in comparison to the individual compounds, it is advantageous to use the following:
20 to 95 phr of rubber (A),
80 to 5 phr of the at least one rubber (B),
a quantity of the crosslinking agent (C), whereby the ratio of SiH groups to functional groups that can be crosslinked by hydrosilylation is 0.2 to 20, preferably 0.5 to 5, especially preferably 0.8 to 1.2,
0.05 to 100,000 ppm, preferably 0.1 to 5000 ppm of the hydrosilylation catalyst system (D) and
5 to 800 phr of the at least one filler (E), preferably 10 to 200 phr for non-magnetic fillers, and preferably 200 to 600 phr for magnetic or magnetizable fillers.

In order to improve the mechanical properties of the elastomer blend, for example, in terms of the compression set at 100° C. [212° F.] in air, especially in comparison to the individual compounds, it is advantageous to use the following:
50 to 95 phr of rubber (A),
50 to 5 phr of the at least one rubber (B),
a quantity of the crosslinking agent (C), whereby the ratio of SiH groups to functional groups that can be crosslinked by hydrosilylation is 0.2 to 20, preferably 0.5 to 5, especially preferably 0.8 to 1.2,
0.05 to 100,000 ppm, preferably 0.1 to 5000 ppm of the hydrosilylation catalyst system (D) and
5 to 800 phr of the at least one filler (E), preferably 10 to 200 phr for non-magnetic fillers, and preferably 200 to 600 phr for magnetic or magnetizable fillers.

In a preferred embodiment, the elastomer blend additionally contains
0.1 to 30 phr, preferably 1 to 10 phr, of the co-agent (F) and/or
0.1 to 20 phr of the at least one additive (G).

The abbreviation phr means parts per hundred of rubber; in other words it indicates the parts by weight per hundred parts by weight of rubber. The indicated ranges of the individual components allow a very specific adaptation of the elastomer blend to the desired properties.

Surprisingly good mechanical properties, especially very low compression set values, particularly at 100° C. [212° F.] in air, are obtained with elastomer blends that preferably contain 50 to 70 phr of rubber (A) and 50 to 30 phr of rubber (B).

Surprisingly good properties, especially very good tensile strength values and/or relatively low gas permeability values, are obtained with elastomer blends that preferably contain 20 to 50 phr of rubber (A) and 80 to 50 phr of rubber (B).

Surprisingly good storage stability values at temperatures above 100° C. [212° F.], especially at 120° C. to 150° C. [248° F. to 302° F.], in air and/or low compression set values at temperatures above 100° C. [212° F.], especially at 120° C. to 150° C. [248° F. to 302° F.], after days or weeks in air, and/or low compression set values, especially after as much as several weeks under fuel cell conditions in an aqueous-acidic medium, are obtained with elastomer blends that preferably have 20 to 50 phr of rubber (A) and 80 to 50 phr of rubber (B), especially preferably 20 phr of rubber (A) and 80 phr of rubber (B).

Preferred elastomer blends have proven to be those for which rubber (A) is selected from among
ethylene propylene diene monomer rubber (EPDM), whereby as the diene, preferably a norbornene derivative having a vinyl group, preferably 5-vinyl-2-norbornene, is used,
isobutylene isoprene divinyl benzene rubber (IIR terpolymer), isobutylene isoprene rubber (IIR), butadiene rubber (BR), styrene butadiene rubber (SBR), styrene isoprene rubber (SIR), isoprene butadiene rubber (IBR), isoprene rubber (IR), acrylonitrile butadiene rubber (NBR), chloroprene rubber (CR), acrylate rubber (ACM) or
partially hydrated rubber made of butadiene rubber (BR), styrene butadiene rubber (SBR), isoprene butadiene rubber (IBR), isoprene rubber (IR), acrylonitrile butadiene rubber (NBR) or rubber functionalized, for example, with maleic acid anhydride or maleic acid anhydride derivatives, or perfluoropolyether rubber functionalized with vinyl groups.

A preferred rubber (B) is selected from among one of the rubbers cited as rubber (A) and/or polyisobutylene rubber (PIB) having two vinyl groups, whereby the rubbers (A) and (B) are not the same in a given elastomer blend, that is to say, they are at least two chemically different rubbers with different properties.

An especially preferred elastomer blend contains ethylene propylene diene monomer rubber (EPDM) having a vinyl group in the diene as rubber (A) and polyisobutylene (PIB) having two vinyl groups as rubber (B).

Advantageously, the mean molecular weight of rubbers (A) and (B) is between 5000 and 100,000 g/mol, preferably between 5000 and 60,000 g/mol.

The following are preferably used as the crosslinking agent (C):
a compound containing SiH and having the Formula (I):

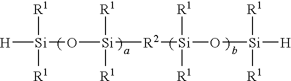

wherein R¹ stands for a saturated hydrocarbon group or for an aromatic hydrocarbon group that is monovalent, that has 1 to 10 carbon atoms and that is substituted or unsubstituted, whereby a stands for integers ranging from 0 to 20 and b stands for integers ranging from 0 to 20, and R² stands for a bivalent organic group having 1 to 30 carbon atoms or oxygen atoms,
a compound containing SiH and having the Formula (II):

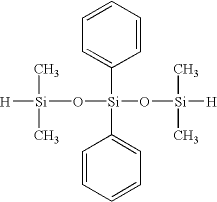

and/or
a compound containing SiH and having the Formula (III):

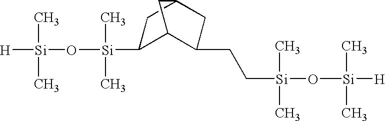

The crosslinking agent (C) is especially selected from among poly(dimethyl siloxane co-methyl hydrosiloxane), tris(dimethyl silyoxy)phenyl silane, bis(dimethyl silyloxy)diphenyl silane, polyphenyl(dimethyl hydrosiloxy)siloxane, methyl hydrosiloxane phenyl methyl siloxane copolymer, methyl hydrosiloxane alkyl methyl siloxane copolymer, polyalkyl hydrosiloxane, methyl hydrosiloxane diphenyl siloxane alkyl methyl siloxane copolymer and/or polyphenyl methyl siloxane methyl hydrosiloxane.

The hydrosilylation catalyst system (D) is preferably selected from among platinum(0)-1,3-divinyl-1,1,3,3,-tetramethyl disiloxane complex, hexachloroplatinic acid, dichloro(1,5-cyclooctadiene)platinum(II), dichloro(dicyclopentadienyl)-platinum(II), tetrakis(triphenyl phosphine)platinum(0), chloro(1,5-cyclooctadiene)rhodium(I)dimer, chlorotris(triphenyl phosphine)rhodium(I) and/or dichloro(1,5-cyclooctadiene)palladium(II), optionally in combination with a kinetics regulator selected from among dialkyl maleate, especially dimethyl maleate, 1,3,5,7-tetramethyl-1,3,5,7-tetravinyl cyclosiloxane, 2-methyl-3-butin-2-ol and/or 1-ethinyl cyclohexanol.

The at least one filler (E) is advantageously selected from furnace, flame and/or channel black, silicic acid, metal oxide, metal hydroxide, carbonate, silicate, surface-modified or hydrophobized, precipitated and/or pyrogenic silicic acid, surface-modified metal oxide, surface-modified metal hydroxide, surface-modified carbonate, such as chalk or dolomite, surface-modified silicate, such as kaolin, calcinated kaolin, talcum, quartz powder, siliceous earth, layer silicate, glass beads, fibers and/or organic fillers such as, for example, wood flour and/or cellulose.

The co-agent (F) is advantageously selected from among 2,4,6-tris(allyloxy)-1,3,5-triazine (TAC), triallyl isocyanurate (TAIL), 1,2-polybutadiene, 1,2-polybutadiene derivatives, allyl ethers, especially trimethylol propane diallyl ether, allyl alcohol esters, especially diallyl phtalates, diacrylates, triacrylates, especially trimethyl propane triacrylate, dimethacrylates and/or trimethacrylates, especially trimethylol propane trimethacrylate (TRIM), triallyl phosphonic acid esters and/or butadiene styrene copolymers having at least two functional groups that bond to the rubbers (A) and/or (B) by hydrosilylation.

The following are used as additive (G):
anti-ageing agents, for example, UV absorbers, UV screeners, hydroxybenzophenone derivatives, benzotriazo derivatives or triazine derivatives,
antioxidants, for example, hindered phenols, lactones or phosphites,
ozone protection agents, for example, paraffinic waxes,
flame retardants,
hydrolysis protection agents, such as carbodiimide derivatives,
bonding agents such as silanes having functional groups that bond to the rubber matrix by hydrosilylation, for example, polymers modified with vinyl trimethoxy silane, vinyl triethoxy silane, with rubbers functionalized with maleic acid derivatives, for example, maleic acid anhydride,
mold release agents or agents for reducing the tackiness of components such as, for instance, waxes, fatty acid salts, polysiloxanes, polysiloxanes having functional groups that bond to the rubber matrix by hydrosilylation and/or
dyes and/or pigments,
plasticizers and/or
processing auxiliaries.

The method for the production of such an elastomer blend does not generate any by-products that have to be removed in a laborious procedure. No decomposition products are released that can migrate and that can be problematic for applications in the realm of fuel cells. Moreover, the crosslinking with a relatively small amount of hydrosilylation catalyst system takes place more quickly than with conventional materials.

In order to produce the elastomer blends described, first of all, rubbers (A) and (B), the at least one filler (E) and optionally the co-agent (F) and/or the at least one additive (G) are mixed, the crosslinking agent (C) and the hydrosilylation catalyst system (D) are added as a one-component system or as a two-component system and all of the components are mixed.

In the case of a one-component system, the crosslinking agent (C) and the hydrosilylation catalyst system (D) are added to the above-mentioned other components in a system or in a container. In contrast, with the two-component system, the crosslinking agent (C) and the hydrosilylation catalyst system (D) are mixed separately from each other, that is to say, in two systems or containers, each at first with part of a mixture of the other components, until they are homogeneously blended, before the two systems, that is to say, the mixture with the crosslinking agent (C) and the mixture with the hydrosilylation catalyst system (D), are combined with each other, and all of the components are mixed together. The two-component system has the advantage that the two mixtures, in which the crosslinking agent (C) and the hydrosilylation catalyst system (D) are separate from each other, can be stored for a longer period of time than a mixture that contains the crosslinking agent (C) as well as the hydrosilylation catalyst system (D).

Subsequently, the product is processed by an injection-molding or (liquid) injection-molding method ((L)IM), by a compression-molding method (CM), by a transfer-molding method (TM) or by a method derived from any of these, by a printing process such as, for example, silkscreen printing, by bead application, dip-molding or spraying.

The above-mentioned elastomer blends are used as material in the area of application of fuel cells, especially of direct methanol fuel cells.

Preferably, the elastomer blends are used as a material for seals such as loose or integrated seals, for instance, 0-rings or chevron-type sealing rings, adhesive seals, soft-metal seals or impregnations, for coatings, membranes or adhesive compounds for hoses, valves, pumps, filters, humidifiers, reformers, storage tanks, vibration absorbers, for coatings of fabrics and/or non-wovens.

An especially advantageous embodiment of the elastomer blends is their use as seals for fuel cell stacks in the form of, for example, profiled or unprofiled seals. Preferably, the elastomer blends according to the invention are also used on a bipolar plate, a membrane, a gas diffusion layer or in profiled or unprofiled seals integrated into a membrane-electrode unit.

### Ways to Execute the Invention

Preferred embodiments of this invention will be described below.

Rubbers (A) and (B), a filler (E) and optionally a co-agent (F) are mixed in a mixer, namely, a SpeedMixer DAC 400 FVZ made by the Hausschild & Co. KG company, at temperatures between 30° C. and 60° C. [86° F. and 140° F.] until the components are homogeneously mixed. Subsequently, a crosslinking agent (C) and a hydrosilylation catalyst system (D) are added, and the mixture is further mixed until the components are homogeneously blended.

This mixture is then compression-molded under vulcanization conditions at 150° C. [302° F.], for example, in a press, to form 2 mm-thick plates.

Ethylene propylene 5-vinyl-2-norbornene rubber made by the Mitsui Chemicals company and having a norbornene content of 5.3% by weight and a mean molecular weight of 31,000 g/mol (Mitsui EPDM) is used as rubber (A).

Polyisobutylene (PIB) having two vinyl groups made by the Kaneka company and having a mean molecular weight of 16,000 g/mol (EPION-PIB (EP 400)) is used as rubber (B).

Poly(dimethyl siloxane co-methyl hydrosiloxane) made by the Kaneka company (CR 300) is used as the crosslinking agent (C). CR 300 has more than 3 SiH groups per molecule and is thus especially well-suited for building networks for difunctional vinyl rubbers such as polyisobutylene having two vinyl groups.

A so-called Karstedt catalyst is used as the hydrosilylation catalyst system (D), namely, platinum(0)-1,3-divinyl-1,1,3,3,-tetramethyl disiloxane complex, that has been dissolved in a 5% concentration in xylene and that is used in combination with dimethyl maleate as a kinetics regulator.

Hydrophobized pyrogenic silicic acid made by the Degussa company (Aerosil R8200) is used as the filler (E). Hydrophobized or hydrophobic silicic acids can be incorporated especially well into non-polar rubbers and cause a lesser increase in viscosity as well as a better compression set in comparison to unmodified silicic acids.

The invention can be better understood with reference to the following examples that are shown in the tables as well as in the figures.

In the examples of the elastomer blends and in the comparative examples, the following test methods are used in order to determine the properties of the elastomer blends in comparison to the individual compounds with Mitsui-EPDM or with EPION-PIB (EP400) as the only type of rubber:

| | |
|---|---|
| hardness [Shore A] according to | DIN 53505 |
| compression set [%] according to | DIN ISO 815 |
| (25% deformation; 24 hrs at 100° C. [212° F.] or 24 hrs/ | |
| 70 hrs/1008 hrs at 120° C. [248° F.] or 24 hrs/70 hrs/ | |
| 336 hrs at 150° C. [302° F.] in air or 1008 hrs at 90° C. | |
| [194° F.] in 2.5 M methanol/water solution, acidified with | |
| formic acid), | |
| permeation of nitrogen | DIN 53536 |
| [cm³(NTP) mm/m²h bar] according to (at 80° C. | |
| [176° F.]), | |
| elongation at break [%] and tensile strength [MPa] at | DIN 53504-S2 |
| room temperature according to | and |
| relative change in the elongation at break and tensile | DIN 53508 |
| strength [%] according to | |

(24 hrs/70 hrs/1008 hrs at 120° C. [248° F.] or 24 hrs/70 hrs/1008 hrs at 150° C. [302° F.] in air).

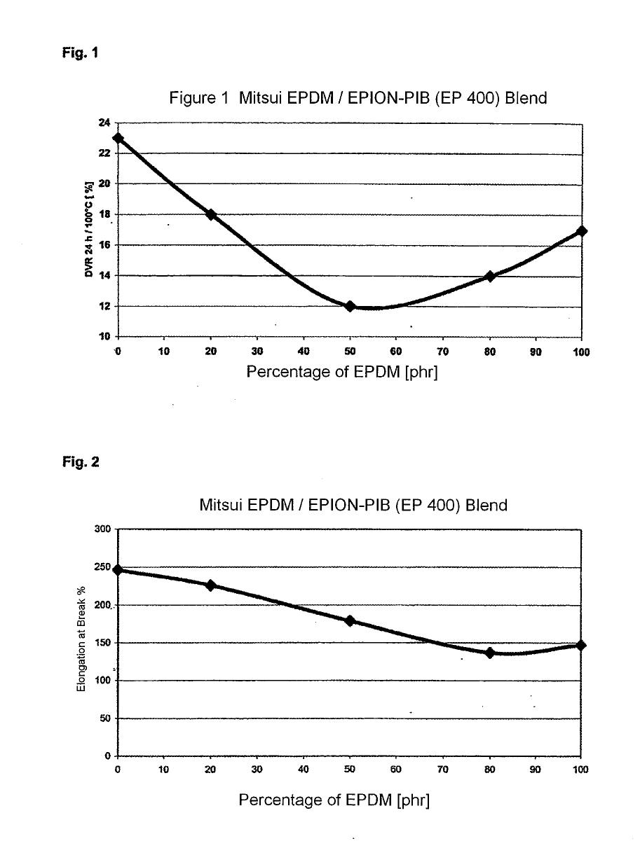

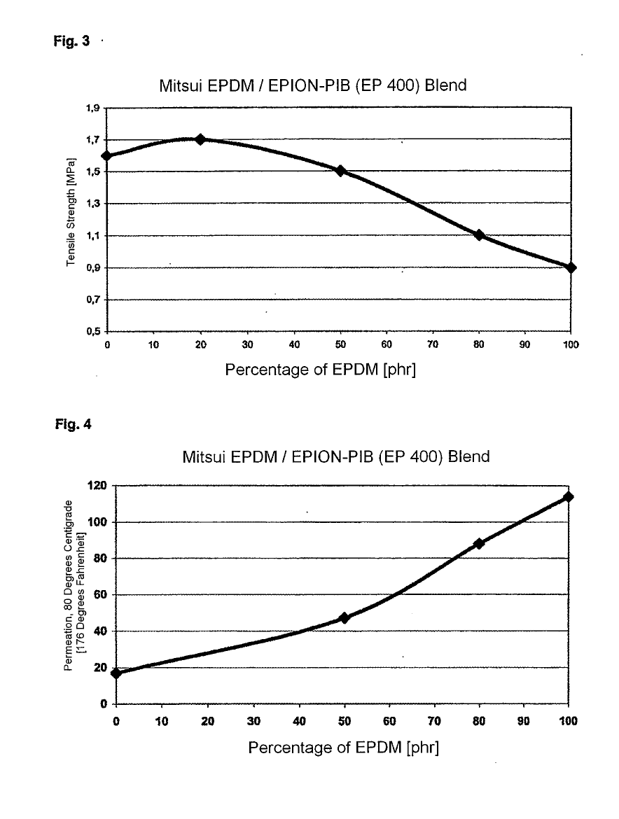

TABLE I

| | Example | | | | |
|---|---|---|---|---|---|
| | Individual | Elastomer | Elastomer | Elastomer | Individual |
| | compound 1 | blend 1 | blend 2 | blend 3 | compound 2 |
| Rubber (A): | 0 | 20 | 50 | 80 | 100 |
| Mitsui EPDM [phr] | | | | | |
| Rubber (B): | 100 | 80 | 50 | 20 | 0 |
| EPION-PIB (EP 400) [phr] | | | | | |
| Crosslinking agent (C): | 4 | 4 | 4 | 4 | 4 |
| CR 300 [phr] | | | | | |
| Catalyst system | 56/36 | 56/36 | 56/36 | 56/36 | 56/36 |
| (D): ≈450 ppm | | | | | |
| catalyst/regulator [μl] | | | | | |
| Filler (E): | 20 | 20 | 20 | 20 | 20 |
| Aerosil R8200 [phr] | | | | | |
| Hardness [Shore A] | 21 | 30 | 31 | 31 | 24 |
| Compression set in air | 23 | 18 | 12 | 14 | 17 |
| 100° C. [212° F.], 24 | | | | | |
| hrs [%] (FIG. 1) | | | | | |
| Elongation at break [%] | 246 | 226 | 179 | 137 | 147 |
| room temperature (FIG. 2) | | | | | |
| Tensile strength [MPa] | 1.6 | 1.7 | 1.5 | 1.1 | 0.9 |
| room temperature (FIG. 3) | | | | | |
| Permeation, 80° C. | 17 | ≈29 | 47 | 88 | 114 |
| [176° F.] [cm³(NTP) | | | | | |
| mm/m²h bar] (FIG. 4) | | | | | |

FIG. 1 shows the curve of the compression set (24 hrs at 100° C. [212° F.] in air),

FIG. 2 shows the curve of the elongation at break (at room temperature),

FIG. 3 shows the curve of the tensile strength (at room temperature) and

FIG. 4 shows the curve of the gas permeability (permeation),

each as a function of the composition of various elastomer blends with Mitsui EPDM as rubber (A) and with EPION-PIB (EP 400) as rubber (B).

The data of Table I and the diagrams in FIGS. 1 through 4 show how the properties can be varied in terms of the compression set, elongation at break, tensile strength and gas-permeability (permeation) by blending different percentages of rubbers (A) and (B) in comparison to the individual compounds, each with only one type of rubber.

Surprisingly, the compression set passes through a minimum (see FIG. 1) at a 1:1 ratio of Mitsui EPDM as rubber (A) to EPION-PIB (EP 400) as rubber (B). Consequently, this elastomer blend 2 has the lowest permanent deformation under load in comparison to other mixing ratios and in comparison to individual compounds 1 and 2 containing only one type of rubber. In general, especially good compression set values are obtained under these conditions with the elastomer blends that contain 50 to 70 phr of a rubber (A) and 50 to 30 phr of a rubber (B).

The elongation at break decreases almost continuously as the percentage of Mitsui EPDM as rubber (A) increases, but at a ratio of 1:1 of Mitsui EPDM as rubber (A) to EPION-PIB (EP 400) as rubber (B), the elongation at break still has relatively good values (see FIG. 2).

At a ratio of 20 phr of Mitsui EPDM as rubber (A) to 80 phr of EPION-PIB (EP 400) as rubber (B) (elastomer blend 1), the tensile strength is best in comparison to the tensile strength values of the blends with other ratios and also in comparison to the tensile strength values of individual compounds 1 and 2. Here, too, the elastomer blend with a 1:1 ratio of Mitsui EPDM to EPION-PIB (EP 400) (elastomer blend 2) likewise still has relatively good tensile strength values (see FIG. 3).

The permeability to nitrogen gas increases as the percentage of Mitsui EPDM rises. In contrast to EPDM, polyisobutylene is relatively gas-tight. As can be seen in

FIG. 4, at a 1:1 ratio of Mitsui EPDM as rubber (A) to EPION-PIB (EP 400) as rubber (B), relatively low gas-permeability values are still achieved.

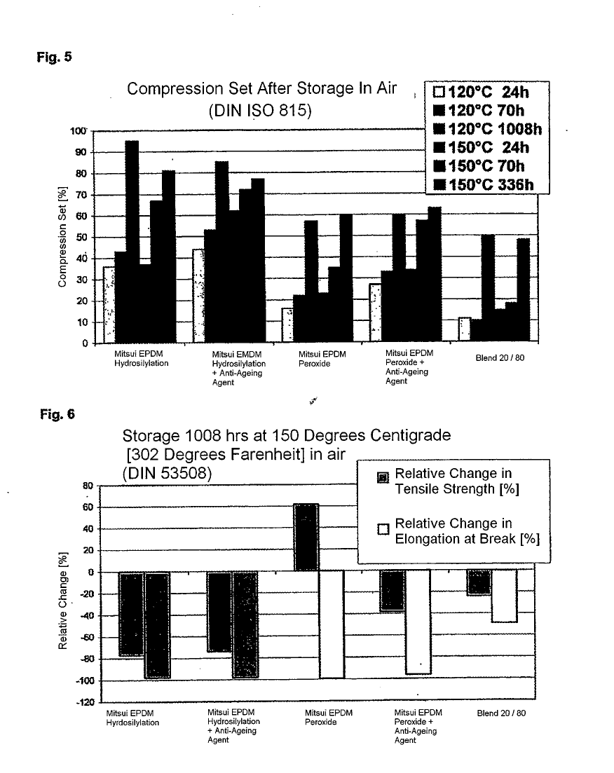

TABLE II

| | Example | | | | |
|---|---|---|---|---|---|
| | | Individual | | Individual | |
| | Individual | compound 2 | Individual | compound 2 | |
| | compound 2 | hydrosilylation + | compound 2 | peroxide + | Elastomer |
| | hydrosilylation | anti-ageing agent | peroxide | anti-ageing agent | blend 1 |
| Rubber (A): | 100 | 100 | 100 | 100 | 20 |
| Mitsui EPDM [phr] | | | | | |
| Rubber (B): | 0 | 0 | 0 | 0 | 80 |
| EPION-PIB [phr] | | | | | |
| Hydrosilylation | 4.5 | 4.5 | 0 | 0 | 4.5 |
| crosslinking agent (C): | | | | | |
| CR 300 [phr] | | | | | |
| Peroxide crosslinking | 0 | 0 | 4 | 4 | 0 |
| agent [phr] | | | | | |
| Catalyst system | 56/36 | 56/36 | 0 | 0 | 56/36 |
| (D): ≈450 ppm | | | | | |
| catalyst/regulator [μl] | | | | | |
| Filler (E): | 30 | 30 | 30 | 30 | 30 |
| Aerosil R8200 [phr] | | | | | |
| Anti-ageing agent (G) | 0 | 2 | 0 | 2 | 0 |
| [phr] | | | | | |
| Compression set [%] | | | | | |
| in air | | | | | |
| 120° C. [248° F.], 24 hrs | 36 | 44 | 16 | 27 | 11 |
| 120° C. [248° F.], 70 hrs | 43 | 53 | 22 | 33 | 10 |
| 120° C. [248° F.], 1008 hrs | 95 | 85 | 57 | 60 | 50 |
| 150° C. [302° F.], 24 hrs | 37 | 62 | 23 | 34 | 15 |
| 150° C. [302° F.], 70 hrs | 67 | 72 | 35 | 57 | 18 |
| 150° C. [302° F.], 336 hrs | 81 | 77 | 60 | 63 | 48 |
| (FIG. 5) | | | | | |
| Storage in air 150° C. | | | | | |
| [302° F.], 1008 | | | | | |
| hrs relative change in tensile | | | | | |
| strength [%] | −77.3 | −73.9 | −61.6 | −38.2 | −24 |
| elongation at break [%] (FIG. 6) | −97.9 | −98.3 | −99.5 | −96.2 | −48.9 |

| | Individual | Individual | | |
|---|---|---|---|---|
| Production | compound 2 | compound 2 | Elastomer | Liquid |
| of the test | hydrosilylation | peroxide | Blend 1 | silicon |
| plates | (+anti-ageing agent) | (+anti-ageing agent) | (+anti-ageing agent) | hydrosilylation |
| Temperature | 150° C. [302° F.] | 180° C. [356° F.] | 150° C. [302° F.] | 150° C. [302° F.] |
| Time [min] | 10 | 10 | 10 | 10 |

TABLE III

| | Example | | | | |
|---|---|---|---|---|---|
| | | Individual | | Individual | |
| | Individual | compound 2 | Individual | compound 2 | |
| | compound 2 | hydrosilylation + | compound 2 | peroxide + | Elastomer |
| | hydrosilylation | anti-ageing agent | peroxide | anti-ageing agent | blend 1 |
| Hardness [Shore A] | | | | | |
| 120° C. [248° F.], 24 hrs | 44 | 41 | 64 | 53 | 32 |
| 120° C. [248° F.], 70 hrs | 47 | 45 | 67 | 55 | 32 |
| 120° C. [248° F.], 1008 hrs | 74 | 59 | 85 | 63 | 40 |
| 150° C. [302° F.], 24 hrs | 47 | 45 | 70 | 57 | 33 |
| 150° C. [302° F.], 70 hrs | 47 | 45 | 77 | 59 | 32 |
| 150° C. [302° F.], 336 hrs | 97 | 66 | 95 | 92 | 43 |
| Tensile strength [MPa] | | | | | |
| 120° C. [248° F.], 24 hrs | 4.7 | 4.9 | 3.8 | 4.9 | 2.8 |
| 120° C. [248° F.], 70 hrs | 4.8 | 4.5 | 2.6 | 6 | 2.7 |
| 120° C. [248° F.], 1008 hrs | 0.9 | 6 | 3.1 | 7.6 | 2.8 |
| 150° C. [302° F.], 24 hrs | 4.8 | 5.1 | 1.5 | 6.3 | 2.5 |
| 150° C. [302° F.], 70 hrs | 5.3 | 5.4 | 1.2 | 6.5 | 2.6 |
| 150° C. [302° F.], 1008 hrs | 1 | 1.2 | 8.4 | 3.4 | 1.9 |
| Elongation at break [%] | | | | | |
| 120° C. [248° F.], 24 hrs | 269 | 285 | 120 | 216 | 222 |
| 120° C. [248° F.], 70 hrs | 241 | 247 | 74 | 227 | 213 |
| 120° C. [248° F.], 1008 hrs | 16 | 175 | 13 | 168 | 170 |
| 150° C. [302° F.], 24 hrs | 226 | 253 | 30 | 200 | 188 |
| 150° C. [302° F.], 70 hrs | 268 | 287 | 13 | 191 | 200 |
| 150° C. [302° F.], 1008 hrs | 8 | 7 | 1 | 10 | 118 |
| Storage in air | | | | | |
| Relative change in | | | | | |
| tensile strength [%] | | | | | |
| 120° C. [248° F.], 24 hrs | 6.8 | 6.5 | −26.9 | −10.9 | 12 |
| 120° C. [248° F.], 70 hrs | 9.1 | −2.2 | −50 | 9.1 | 8 |
| 120° C. [248° F.], 1008 hrs | 0.9 | 6 | 3.1 | 38.2 | 12 |
| 150° C. [302° F.], 24 hrs | 9.1 | 10.9 | −71.2 | 14.5 | 0 |
| 150° C. [302° F.], 70 hrs | 20.5 | 17.4 | −36.8 | 18.2 | 4 |
| Elongation at break [%] | | | | | |
| 120° C. [248° F.], 24 hrs | −29.2 | −30.8 | −35.8 | −17.6 | −3.9 |
| 120° C. [248° F.], 70 hrs | −36.6 | −40 | −60.4 | −13.4 | −7.8 |
| 120° C. [248° F.], 1008 hrs | −95.8 | −57.5 | −93 | −35.9 | −26.4 |
| 150° C. [302° F.], 24 hrs | −40.5 | −38.6 | −84 | −23.7 | −18.6 |
| 150° C. [302° F.], 70 hrs | −29.5 | −30.3 | −93 | −27.1 | −13.4 |

FIG. 5 shows the compression set after various periods of time at 120° C. [248° F.] and 150° C. [302° F.] in air and

FIG. 6 shows the relative change in the tensile strength and the relative change in the elongation at break after 1008 hrs at 150° C. [302° F.] in air,

as a function of elastomer blend 1 with 20 phr of Mitsui EPDM as rubber (A) and with 80 phr of EPION-PIB (EP 400) as rubber (B) or as a function of individual compound 2 (100 phr of EPDM) with the hydrosilylation crosslinking agent (C) or with a peroxide crosslinking agent as well as with and without a phenolic anti-ageing agent as additive (G).

2,5-Dimethyl-2,5-di(tert-butyl peroxy)hexane made by Arkema Inc. (Luperox 101 XL-45) is used as the peroxide crosslinking agent for the Mitsui EPDM.

Irganox 1076 made by the Ciba-Geigy company is used as the phenolic anti-ageing agent.

The data of Table II and III as well as the diagrams in FIGS. 5 and 6 show that elastomer blend 1 with 20 phr of Mitsui EPDM as rubber (A) and with 80 phr of EPION-PIB (EP 400) as rubber (B) exhibits much lower compression set values in comparison to individual compound 2 (100 phr of Mitsui EPDM) crosslinked by hydrosilylation or by peroxide, as well as lesser changes in the properties such as hardness, elongation at break and tensile strength. Surprisingly, the same applies to individual compound 2 (100 phr of Mitsui EPDM) crosslinked by hydrosilylation or by peroxide with the addition of anti-ageing agents.

Compression set values of more than 50% are considered to be unacceptable for many areas of application.

The elastomer blends according to the invention display particularly high strength in comparison to an individual compound, even at high temperatures of up to 160° C. [320° F.].

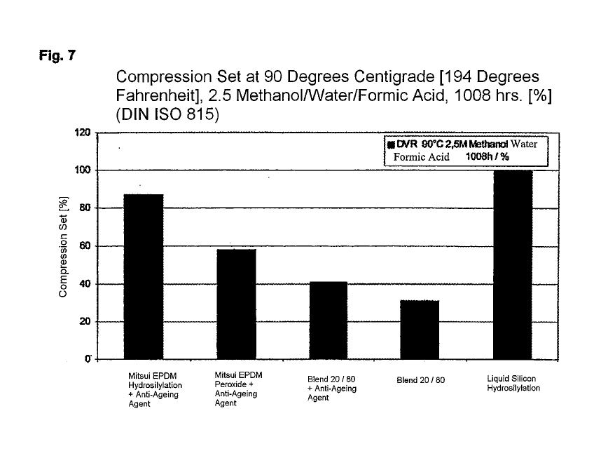

TABLE IV

| | Example | | | | |
|---|---|---|---|---|---|
| | Individual | Individual | | | |
| | compound 2 | compound 2 | Elastomer | | Liquid |
| | hydrosilylation + | peroxide + | blend 1 + | Elastomer | silicon |
| | anti-ageing agent | anti-ageing agent | anti-ageing agent | blend 1 | hydrosilylation |
| Rubber (A): | 100 | 100 | 20 | 20 | silicon 50 |
| Mitsui EPDM [phr] | | | | | |
| Rubber (B): | 0 | 0 | 80 | 80 | silicon 50 |
| EPION-PIB [phr] | | | | | |
| Hydrosilylation | 4.5 | 0 | 4.5 | 4.5 | |
| crosslinking agent (C): | | | | | |
| CR 300 [phr] | | | | | |
| Peroxide crosslinking | 0 | 4 | 0 | 0 | |
| agent [phr] | | | | | |
| Catalyst system | 56/36 | 0 | 56/36 | 56/36 | |
| (D): ≈450 ppm | | | | | |
| catalyst/regulator [μl] | | | | | |
| Filler (E): | 30 | 30 | 30 | 30 | |
| Aerosil R8200 [phr] | | | | | |
| Anti-ageing agent (G) | 2 | 2 | 2 | 0 | |
| [phr] | | | | | |
| Compression set [%] | 87 | 58 | 41 | 31 | 100 |
| in 2.5 M | | | | | |
| CH₃OH/H₂O/HCO₂H | | | | | |
| 90° C. [194° F.], 1008 hrs | | | | | |
| (FIG. 7) | | | | | |

FIG. 7 shows the compression set after 1008 hrs at 90° C. [194° F.] in 2.5 M methanol/water/formic acid),

as a function of elastomer blend 1 with 20 phr of Mitsui EPDM as rubber (A) and with 8 phr of EPION-PIB (EP 400) as rubber (B) with and without a phenolic anti-ageing agent as additive (G) or as a function of individual compound 2 (100 phr of EPDM) with the hydrosilylation crosslinking agent (C) or with a peroxide crosslinking agent as well as with and without a phenolic anti-ageing agent as additive (G) or as a function of a conventional hydrosilylated silicon mixture (50/50, hardness 40 Shore A).

2,5-Dimethyl-2,5-di(tert-butylperoxy)hexane made by Arkema Inc. (Luperox 101 XL-45) is used as the peroxide crosslinking agent.

Irganox 1076 made by the Ciba-Geigy company is used as the phenolic anti-ageing agent.

The data of Table IV as well as the diagram in FIG. 7 show that elastomer blend 1 with 20 phr of Mitsui EPDM as rubber (A) and with 80 phr of EPION-PIB (EP 400) as rubber (B) with and without an anti-ageing agent has much lower compression set values in comparison to individual compound 2 (100 phr of Mitsui EPDM) crosslinked by hydrosilylation or by peroxide or in comparison to a conventional hydrosilylated silicon mixture (50/50, hardness 40 Shore A) after 1008 hrs at 90° C. [194° F.] in a 2.5 M methanol/water solution that is acidified with formic acid.

In contrast to the individual compounds and to a conventional hydrosilylated silicon mixture, the elastomer blends exhibit compression set values of less than 50%, even under the cited conditions.

Therefore, the elastomer blends stand out for their excellent resistance in aqueous-acidic media such as aqueous-acidic alcohol solutions and therefore, they lend themselves as a material for seals or impregnations, coatings, membranes or adhesive compounds and/or vibration absorbers in this environment. Advantageously, the elastomer blends are especially well-suited for use in direct methanol fuel cells (DMFC).

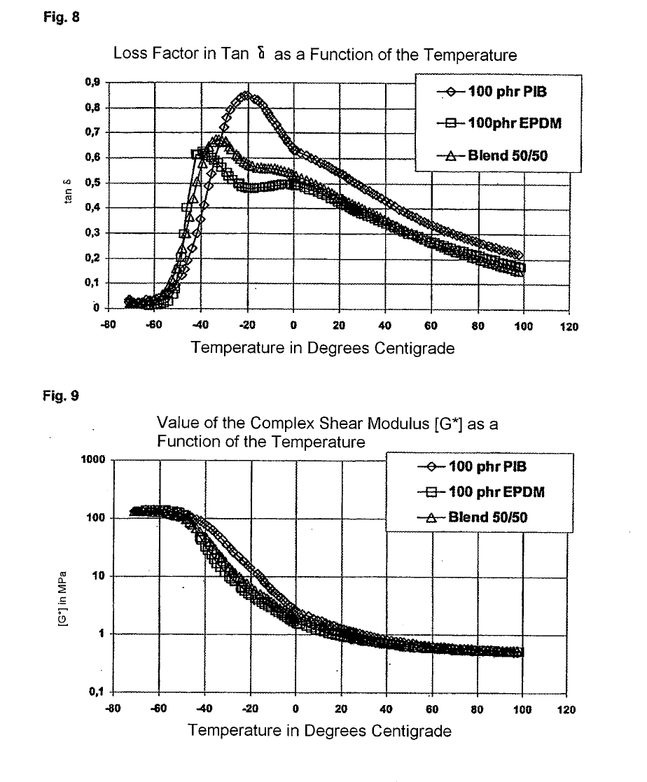

FIG. 8 shows the curve of the loss factor regarding the mechanical damping behavior under dynamic shear stress (measured according to DIN EN ISO/IEC 17025 accredited, double sandwich test specimens, temperature range from −70° C. to 100° C. [−94° F. to 212° F.]; heating rate of 1K/min; increment 2K; testing frequency of 1 Hz; relative shear deformation of ±2.5%) as a function of the temperature for elastomer blend 1 with 20 phr of Mitsui EPDM as rubber (A) and with 80 phr of EPION-PIB (EP 400) as rubber (B) in comparison to individual compound 1 (100 phr of EPION-PIB) and in comparison to individual compound 2 (100 phr of Mitsui EPDM).

FIG. 9 shows the curve of the complex shear modulus G (measured according to DIN EN ISO/IEC 17025 accredited, double sandwich test specimens, temperature range from −70° C. to 100° C. [−94° F. to 212° F.]; heating rate of 1 K/min; increment 2K; testing frequency of 1 Hz; relative shear deformation of ±2.5%) as a function of the temperature for elastomer blend 1 with 20 phr of Mitsui EPDM as rubber (A) and with 80 phr of EPION-PIB (EP 400) as rubber (B) in comparison to individual compound 1 (100 phr of EPION-PIB) and in comparison to individual compound 2 (100 phr of Mitsui EPDM).

The diagrams in FIGS. 8 and 9 show how the mechanical damping behavior under dynamic shear stress can be varied through the selection of the rubber composition.

This is significant for the design of dynamically stressed components.

Consequently, as shown above, the elastomer blends stand out for their excellent temperature and media resistance.

TABLE V

| | Example | | | | |
|---|---|---|---|---|---|
| | | Elastomer | Elastomer | Elastomer | |
| | | blend 1 with | blend 1 with | blend 3 with | |
| | Elastomer | co-agent (F) | co-agent (F) | co-agent (F) | Elastomer |
| | blend 1 | Nisso | TAIC | TAIC | blend 3 |
| Rubber (A): | 20 | 20 | 20 | 80 | 80 |
| Mitsui EPDM [phr] | | | | | |
| Rubber (B): | 80 | 80 | 80 | 20 | 20 |
| EPION-PIB (EP 400) | | | | | |
| (phr] | | | | | |
| Crosslinking agent (C): | 4 | 10 | 10 | 10 | 4 |
| CR 300 [phr] | | | | | |
| Catalyst system (D): | 0.2/35 | 0.2/35 | 0.2/35 | 0.2/35 | 0.2/35 |
| catalyst/regulator [μl] | | | | | |
| Filler (E): | 20 | 20 | 20 | 20 | 20 |
| Aerosil R8200 [phr] | | | | | |
| Co-agent (F): [phr] | | 1 | 1 | 1 | |
| Nisso PB B 3000 | | | | | |
| TAIC | | | | | |
| Hardness [Shore A] | 30 | 38 | 37 | 40 | 31 |
| Compression set at | 28 | 39 | 27 | 22 | 36 |
| 120° C. [248° F.], 24 hrs | | | | | |
| (%) | | | | | |
| Elongation at break [%] | 226 | 170 | 210 | 110 | 137 |
| Tensile strength [MPa] | 1.7 | 2.7 | 2.5 | 2.8 | 1.1 |

Triallyl isocyanurate (TAIC) made by the Nordmann, Rassmann GmbH company or else 1,2-polybutadiene (Nisso PB B-3000) made by Nippon Soda Co., Ltd. is used as the co-agent (F) that can be crosslinked by hydrosilylation.

The data of Table V—in addition to the examples presented so far of elastomer blends without a co-agent, referring to the example of the use of the co-agent triallyl isocyanurate (TAIC) or 1,2-polybutadiene (Nisso PB B-3000) as an additive to elastomer blend 1 (20 phr EPDM/80 phr PIB) and elastomer blend 3 (80 phr EPDM/20 phr PIB)—shows the effect that the addition of a co-agent (F) that that can be crosslinked by hydrosilylation has on the mechanical properties.

The hardness values as well as the tensile strength values are increased through the addition of a co-agent (F).

The compression set is further improved, especially through the addition of triallyl isocyanurate (TAIC) as the co-agent (F), even at a temperature of 120° C. [248° F.] after 24 hours.

This shows that further optimization possibilities in the realm of the mechanical properties exist for elastomer blends that contain a co-agent of the above-mentioned type.

1-17. (canceled)

18. A fuel cell material for use in an application area of a fuel cell comprising: an elastomer blend, wherein the elastomer blend comprises:
a first rubber having at least two functional groups that can be crosslinked by hydrosilylation;
at least one other rubber having at least two functional groups that can be crosslinked by hydrosilylation, wherein the at least one other rubber differs chemically from the first rubber;
a hydrosiloxane or hydrosiloxane derivative or a mixture of several hydrosiloxanes or hydrosiloxane derivatives that, on average, have at least two SiH groups per molecule as the crosslinking agent;
a hydrosilylation catalyst system; and
at least one filler.

19. The fuel cell material as recited in claim 18, wherein the fuel cell material is a direct methanol fuel cell material.

20. The fuel cell material as recited in claim 18, wherein the elastomer blend further comprises a co-agent that can be crosslinked by hydrosilylation and/or at least one additive.

21. The fuel cell material as recited in claim 18, wherein the first rubber has more than two functional groups that can be crosslinked by hydrosilylation and the at least one other rubber has two functional groups that can be crosslinked by hydrosilylation.

22. The fuel cell material as recited in claim 21, wherein the the two functional groups are two vinyl groups.

23. The fuel cell material as recited in claim 18, wherein the elastomer blend contains
20 to 95 phr of the first rubber;
80 to 5 phr of the at least one other rubber;
a quantity of the crosslinking agent, wherein the ratio of SiH groups to functional groups that can be crosslinked by hydrosilylation is 0.2 to 20;
0.05 to 100,000 ppm of the hydrosilylation catalyst system; and
5 to 800 phr of the at least one filler.

24. The fuel cell material as recited in claim 23, wherein the ratio of the SiH groups to functional groups that can be crosslinked by hydrosilylation is 0.5-5.

25. The fuel cell material as recited in claim 24, wherein the ratio of the SiH groups to functional groups that can be crosslinked by hydrosilylation is 0.8-1.2.

26. The fuel cell material as recited in claim 23, wherein the amount of the hydrosilylation catalyst system is 0.1 to 5,000 ppm.

27. The fuel cell material as recited in claim 23, wherein the amount of filler is 10 to 200 phr for nonmagnetic fillers or 200 to 600 phr for magnetic or magnetizable fillers.

28. The fuel cell material as recited in claim 18, wherein the elastomer blend contains
50 to 95 phr of the first rubber;
50 to 5 phr of the at least one other rubber;
a quantity of the crosslinking agent, wherein the ratio of SiH groups to functional groups that can be crosslinked by hydrosilylation is 0.2 to 20;
0.05 to 100,000 ppm of the hydrosilylation catalyst system; and
5 to 800 phr of the at least one filler.

29. The fuel cell material as recited in claim 28, wherein the ratio of the SiH groups to functional groups that can be crosslinked by hydrosilylation is 0.5-5.

30. The fuel cell material as recited in claim 29, wherein the ratio of the SiH groups to functional groups that can be crosslinked by hydrosilylation is 0.8-1.2.

31. The fuel cell material as recited in claim 28, wherein the amount of the hydrosilylation catalyst system is 0.1 to 5,000 ppm.

32. The fuel cell material as recited in claim 28, wherein the amount of filler is 10 to 200 phr for nonmagnetic fillers or 200 to 600 phr for magnetic or magnetizable fillers.

33. The fuel cell material as recited in claim 20, wherein the elastomer blend contains
0.1 to 30 phr of the co-agent; and/or 0.1 to 20 phr of the at least one additive.

34. The fuel cell material as recited in claim 33, wherein the amount of coagent is 1 to 10 phr.

35. The fuel cell material as recited in claim 18, wherein the elastomer blend contains 50 to 70 phr of the first rubber and 50 to 30 phr of the at least one other rubber.

36. The fuel cell material as recited in claim 18, wherein rubber is selected from among
ethylene propylene diene monomer rubber (EPDM);
isobutylene isoprene divinyl benzene rubber (IIR terpolymer), isobutylene isoprene rubber (IIR), butadiene rubber (BR), styrene butadiene rubber (SBR), styrene isoprene rubber (SIR), isoprene butadiene rubber (IBR), isoprene rubber (IR), acrylonitrile butadiene rubber (NBR), chloroprene rubber (CR), acrylate rubber (ACM) or
partially hydrated rubber made of butadiene rubber (BR), styrene butadiene rubber (SBR), isoprene butadiene rubber (IBR), isoprene rubber (IR), acrylonitrile butadiene rubber (NBR) or functionalized rubber.

37. The fuel cell material as recited in claim 36, wherein the ethylene-propylene-diene monomer rubber is a norbornene derivative having a vinyl group.

38. The fuel cell material as recited in claim 37, wherein the norbornene derivative having a vinyl group is 5-vinyl-2-norbornene.

39. The fuel cell material as recited in claim 36, wherein the functionalized rubber is functionalized with maleic anhydride or maleic acid anhydride derivatives or is perfluoropolyether rubber functionalized with vinyl groups.

40. The fuel cell material as recited in claim 18, wherein the at least one other rubber is selected from among
ethylene propylene diene monomer rubber (EPDM);
isobutylene isoprene divinyl benzene rubber (IIR terpolymer), isobutylene isoprene rubber (IIR), butadiene rubber (BR), styrene butadiene rubber (SBR), styrene isoprene rubber (SIR), isoprene butadiene rubber (IBR), isoprene rubber (IR), acrylonitrile butadiene rubber (NBR), chloroprene rubber (CR), acrylate rubber (ACM); and/or
partially hydrated rubber made of butadiene rubber (BR), styrene butadiene rubber (SBR), isoprene butadiene rubber (IBR), isoprene rubber (IR), acrylonitrile butadiene rubber (NBR), polyisobutylene rubber (PIB) having two vinyl groups or rubber of the cited rubbers functionalized with maleic acid derivatives such as maleic acid anhydride, and/or perfluoropolyether rubber functionalized with vinyl groups.

41. The fuel cell material as recited in claim 40, wherein the ethylene-propylene-diene monomer rubber is a norbornene derivative having a vinyl group.

42. The fuel cell material as recited in claim 41, wherein the norbornene derivative having a vinyl group is 5-vinyl-2-norbornene.

43. The fuel cell material as recited in claim 18, wherein the first rubber is selected from ethylene propylene diene monomer rubber (EPDM) having a vinyl group in the diene and the at least one other rubber is selected from polyisobutylene (PIB) having two vinyl groups.

44. The fuel cell material as recited in claim 18, wherein the mean molecular weight of the first rubber and the at least one other rubber is between 5000 and 100,000 g/mol.

45. The fuel cell material as recited in claim 44, wherein the mean molecular weight of the first rubber and the at least one other rubber is between 5000 and 60,000 g/mol.

46. The fuel cell material as recited in claim 18, wherein the crosslinking agent is selected from among
a compound containing SiH and having the Formula (I): 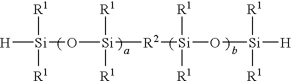
wherein R¹ stands for a saturated hydrocarbon group or for an aromatic hydrocarbon group that is monovalent, that has 1 to 10 carbon atoms and that is substituted or unsubstituted, wherein a stands for integers ranging from 0 to 20 and b stands for integers ranging from 0 to 20, and R² stands for a bivalent organic group having 1 to 30 carbon atoms or oxygen atoms,
a compound containing SiH and having the Formula (II): 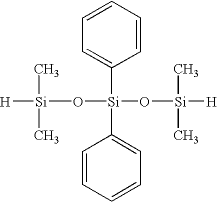
and/or
a compound containing SiH and having the Formula (III):

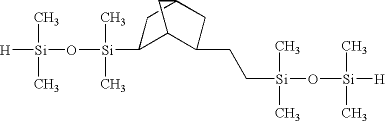

47. The fuel cell material as recited in claim 46, wherein the crosslinking agent includes poly(dimethyl siloxane co-methyl hydrosiloxane), tris(dimethyl silyoxy)phenyl silane, bis(dimethyl silyloxy)diphenyl silane, polyphenyl(dimethyl hydrosiloxy)siloxane, methyl hydrosiloxane phenyl methyl siloxane copolymer, methyl hydrosiloxane alkyl methyl siloxane copolymer, polyalkyl hydrosiloxane, methyl hydrosiloxane diphenyl siloxane alkyl methyl siloxane copolymer and/or polyphenyl methyl siloxane methyl hydrosiloxane.

48. The fuel cell material as recited in claim 18, wherein the hydrosilylation catalyst system is selected from among hexachloroplatinic acid, platinum(0)-1,3-divinyl-1,1,3,3,-tetramethyl disiloxane complex, dichloro(1,5-cyclooctadiene)platinum(II), dichloro(dicyclopentadienyl)-platinum(II), tetrakis(triphenyl phosphine)platinum(0), chloro(1,5-cyclooctadiene)rhodium(I)dimer, chlorotris(triphenyl phosphine)rhodium(I) and/or dichloro(1,5-cyclooctadiene)palladium(II).

49. The fuel cell material as recited in claim 48, further comprising a kinetic regulator selected from among dialkyl maleate, especially dimethyl maleate, 1,3,5,7-tetramethyl-1,3,5,7-tetravinyl cyclosiloxane, 2-methyl-3-butin-2-ol and/or 1-ethinyl cyclohexanol.

50. The fuel cell material as recited in claim 18, wherein the at least one filler is selected from carbon black, graphite, silicic acid, silicate, metal oxide, metal hydroxide, carbonate, glass beads, fibers and/or organic fillers.

51. The fuel cell material as recited by claim 20, wherein the co-agent is selected from among 2,4,6-tris(allyloxy)-1,3,5-triazine (TAC), triallyl isocyanurate (TAIC), 1,2-polybutadiene, 1,2-polybutadiene derivatives, allyl ethers, allyl alcohol esters, phtalates, diacrylates, triacrylates, dimethacrylates and/or trimethacrylates, triallyl phosphonic acid esters and/or butadiene styrene copolymers having at least two functional groups that bond to the rubber and/or at least one other rubber by hydrosilylation.

52. The fuel cell material as recited by claim 51, wherein the allyl ethers is trimethylol propane diallyl ether.

53. The fuel cell material as recited by claim 51, wherein the allyl alcohol esters is diallyl phtalates.

54. The fuel cell material as recited by claim 51, wherein the triacrylates is trimethyl propane triacrylate.

55. The fuel cell material as recited by claim 51, wherein the trimethacrylates is trimethylol propane trimethacrylate (TRIM).

56. The use as recited by claim 20, wherein the at least one additive is selected from among anti-ageing agents, antioxidants, ozone protection agents, flame retardants, hydrolysis protection agents, bonding agents, mold release agents or agents for reducing the tackiness of components, colorants and/or pigments, plasticizers and/or processing auxiliaries.

57. The fuel cell material as recited in claim 18 wherein the area of application is as a material for seals or impregnations, coatings, membranes or adhesive compounds for hoses, valves, pumps, filters, humidifiers, reformers, storage tanks, vibration absorbers, for coatings of fabrics and/or non-wovens.

58. A method for manufacturing a fuel cell comprising: placing the fuel cell material as recited in claim 18 in the application area.
